(19) United States
(12) Patent Application Publication
(10) Pub. No.: US 2026/0347224 A1
(43) Pub. Date: Nov. 5, 2026

(54) DISINFECTING WATER HARVESTED FROM AIR

(71) Applicant: SAUDI ARABIAN OIL COMPANY, Dhahran (SA)

(72) Inventor: Mousa O. Alharthi, Dammam (SA)

(73) Assignee: SAUDI ARABIAN OIL COMPANY, Dhahran (SA)

(21) Appl. No.: 19/194,357

(22) Filed: Apr. 30, 2025

(51) Int. Cl. C02F 1/78; C02F 103/02

(52) U.S. Cl. CPC C02F 1/78; C02F 2103/02; C02F 2201/322; C02F 2201/782; C02F 2303/04

(57) ABSTRACT

A system for purifying water includes an atmospheric water harvester, a mixing injector fluidly connected to and downstream of the atmospheric water harvester, an ozone generator fluidly connected to and upstream of the mixing injector, and a contact chamber in fluid communication with the mixing injector. A method for purifying water includes condensing water from an atmosphere with an atmospheric water harvester, generating ozone with a UV lamp in an ozone generator, mixing the water with the ozone in a mixing injector to yield ozonated water, and holding the ozonated water in a contact chamber for a period of time required for disinfection, thereby producing purified water.

### BACKGROUND

Water in the atmosphere may be condensed to provide drinking water. Lowering the air temperature below the dew point causes the water in the air (i.e., humidity) to condense, thereby producing water. However, the produced water is not disinfected, since air may be polluted with airborne viruses, pathogens, and bacteria. Accordingly, there exists a need for an integrated atmospheric water harvester combined with a disinfection system.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for purifying water. The system may include an atmospheric water harvester, a mixing injector fluidly connected to and downstream of the atmospheric water harvester, an ozone generator fluidly connected to and upstream of the mixing injector, and a contact chamber in fluid communication with the mixing injector.

In another aspect, embodiments disclosed herein relate to a method for purifying water. The method may include condensing water from an atmosphere with an atmospheric water harvester, generating ozone with a UV lamp in an ozone generator, mixing the water with the ozone in a mixing injector to yield ozonated water, and holding the ozonated water in a contact chamber for a period of time required for disinfection, thereby producing purified water.

Other aspects and advantages of the claimed subject matter will be apparent from the following description and the appended claims.

### BRIEF DESCRIPTION OF DRAWINGS

FIG. 1 is a depiction of a system, according to one or more embodiments.

FIG. 2 is a depiction of an atmospheric water harvester, according to one or more embodiments.

FIG. 3 is a depiction of an ozone generator, according to one or more embodiments.

FIG. 4 is a depiction of a mixing injector, according to one or more embodiments.

FIG. 5 is a flow chart of a method, according to one or more embodiments.

### DETAILED DESCRIPTION

In one aspect, embodiments disclosed herein relate to a system and method for purifying water. Water may be harvested from the atmosphere using an atmospheric water harvester. The water may contain pollutants such as airborne viruses, pathogens, and bacteria. As such, the water may require purification. Known disinfection methods include the use of chlorine and the use of ozone. Ozone is more desirable as a disinfectant than chlorine, as ozone does not to leave undesired byproducts in the water. Ozone may be generated by corona discharge or UV radiation. UV radiation is safer than corona discharge, as corona discharge requires a high voltage to produce ozone.

### System for Purifying Water

A schematic for a system is shown in FIG. 1. According to one or more embodiments, the system 100 for purifying water includes an atmospheric water harvester 110, a mixing injector 140 fluidly connected to and downstream of the atmospheric water harvester 110, an ozone generator 130 fluidly connected to and upstream of the mixing injector 140, and a contact chamber 150 in fluid communication with the mixing injector 140.

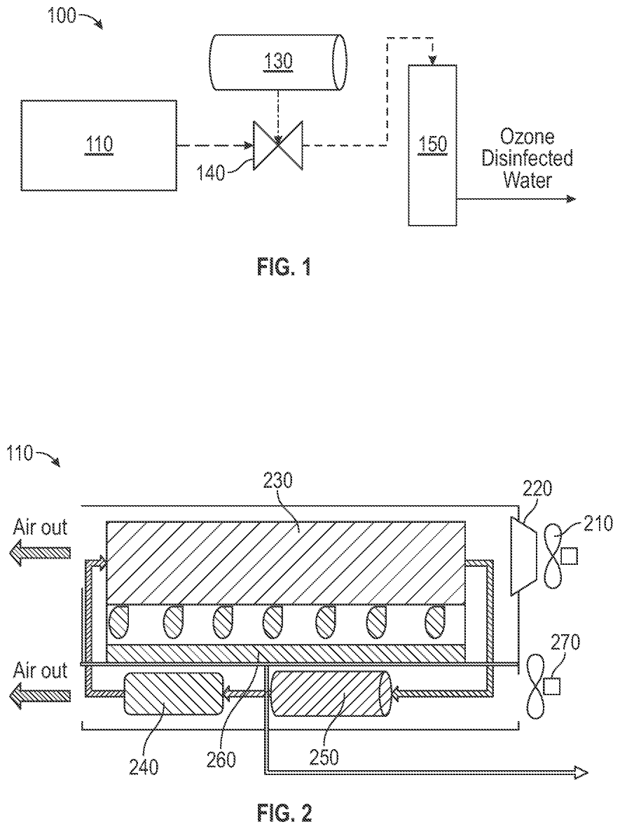

The system 100 includes an atmospheric water harvester 110. The atmospheric water harvester 110 is configured to harvest water from the atmosphere. To harvest water from the atmosphere, the atmospheric humidity may be at least 50% at 25 °C. In one or more embodiments, the atmospheric humidity is at least 70% at 25 °C. The atmospheric water harvester 110 includes a fan system including an air filter, an evaporator fluidly connected to the fan system and configured to produce water and a refrigerant vapor, a condenser fluidly connected to the evaporator and configured to produce a refrigerant liquid, a compressor fluidly connected to the evaporator and the condenser, and a water collection tank fluidly connected to the evaporator, which will be described in greater detail with reference to FIG. 2.

The atmospheric water harvester 110 includes a power source. The power source may be conventional electricity or solar power. Energy required to power the atmospheric water harvester 110 ranges from 200 to 500 watts (W).

The atmospheric water harvester 110 is depicted in further detail in FIG. 2. The atmospheric water harvester 110 includes a first fan system 210. The first fan system 210 draws air from the atmosphere into the atmospheric water harvester 110. The first fan system 210 is an axial fan. The first fan system 210 is attached to an air intake (not pictured) on the atmospheric water harvester 110. An example fan system includes, but is not limited to, a Noctua NF-A4X10 FLX, 40 mm Axial Fan (Noctua).

The fan system 210 includes an air filter 220. The air filter 220 is configured to filter particulates and pollutants out of the air from the atmosphere. The air filter 220 is connected to the fan system 210 by a tube channel. The air filter 220 is a high efficiency particulate air (HEPA) filter. HEPA filters may filter at least 99.97% of airborne particulates that are 0.3 microns or larger. The air filter 220 further includes activated carbon. Activated carbon may filter pollutants from the air in the atmosphere. Pollutants may include volatile organic compounds (VOCs). Activated carbon may further filter pollutants from the air in the atmosphere to provide an enhanced taste and reduced odor of the water harvested. Suppliers for the air filter 220 include, but are not limited to, Camfil and Calgon Carbon Corporation.

The atmospheric water harvester 110 includes an evaporator 230. The evaporator 230 is fluidly connected to the fan system 210. The evaporator 230 removes heat from the air. Once the heat is removed, the air may be at a dew point. The dew point is the temperature at which liquid water forms. The dew point is dependent on temperature, pressure, and humidity of the air. The temperature may range from 20 to 35 °C. The pressure may range from 900 to 1,020 hectopascals (hPa). The humidity may be at least 50%. The evaporator 230 is a finned tube evaporator. The finned tube evaporator may be supplied by Thermo King or Alfa Laval. The evaporator 230 produces water and a refrigerant vapor. The refrigerant may be isobutane (R-600a) or propane (R-290).

The atmospheric water harvester 110 includes a condenser 240. The condenser 240 is fluidly connected to the evaporator 230. The condenser 240 cools the refrigerant vapor into a refrigerant liquid. The condenser 240 is an air-cooled condenser. An example air-cooled condenser may be a Danfoss Microchannel Heat Exchanger. The air-cooled condenser may have coils for which the refrigerant flows. Air flowing above the coils may adsorb heat from the refrigerant vapor, thereby providing the refrigerant liquid. The coils may be comprised of copper, aluminum, or stainless steel.

The atmospheric water harvester 110 includes a compressor 250. The compressor 250 is fluidly connected to the evaporator 230 and condenser 240 in a loop. The compressor 250 includes a refrigerant. The refrigerant may be isobutane (R-600a) or propane (R-290). The compressor 250 cycles the refrigerant through the loop of the evaporator 230 and the condenser 240. The compressor 250 is a piston compressor. The piston compressor may be supplied by Secop or Danfoss. The piston compressor may operate at a pressure ranging from 2 to 6 bars.

The atmospheric water harvester 110 also includes a water collection tank 260. The water collection tank 260 is configured to store water harvested from the atmospheric water harvester 110 prior to purification. The water collection tank 260 is made from a corrosion-resistant stainless steel. An example of corrosion-resistant stainless steel may include Food Grade stainless steel 304 or 316. The water collection tank 260 has a volume capacity of at least 24 liters. Dimensions for the water collection tank 260 may include, but are not limited to, a length of 40 cm, a width of 20 cm, and a height of 30 cm. The atmospheric water harvester 110 further includes a second fan system 270. The second fan system 270 provides air flow to the condenser 240. The second fan system 270 is an axial fan as described for the first fan system 210.

A system 100 for purifying water includes an ozone generator 130. The ozone generator 130 is fluidly connected to and upstream of a mixing injector 140. The ozone generator 130 is configured to produce ozone for purification of the water harvested by the atmospheric water harvester 110. The ozone generator 130 includes a fan, an ozone generator chamber fluidly connected to the fan, a UV lamp contained inside the ozone generator chamber, and a power source connected to the UV lamp. The power source may be connected to a standard 120 V outlet. An example ozone generator 130 is a UV Pro 4000 Ozone Generator supplied by Oxidation Technologies.

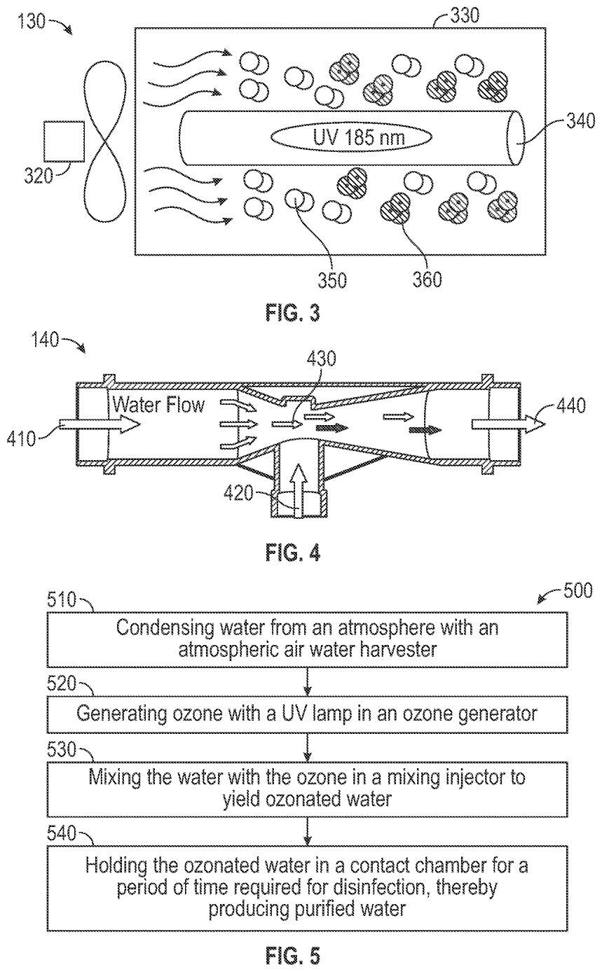

The ozone generator 130 is depicted in further detail in FIG. 3. The ozone generator 130 includes a fan 320. The fan 320 pulls in air containing oxygen into the ozone generator 130. The fan 320 is an axial fan. The axial fan may have a speed ranging from 3500 rotations per minute (rpm) to 6500 rpm. The axial fan may provide air flow ranging from 4.85 to 5.5 cubic meters per hour (m³/h).

The ozone generator 130 includes an ozone generating chamber 330. The ozone generating chamber 330 is fluidly connected to the fan 320. The ozone generating chamber 330 may be stainless steel or glass. The stainless steel may be 304 or 316 stainless steel. The ozone generating chamber 330 has a volume ranging from 170 mL (cm³) to 320 mL. The ozone generating chamber 330 further has a cross-sectional area ranging from 10 to 20 cm². Example dimensions for an ozone generating chamber with a volume of 170 mL include a radius of 1.78 cm and a height of 17 cm.

The ozone generator 130 includes a UV lamp 340 contained inside the ozone generating chamber 330. A UV lamp emits UV radiation in order to form ozone. The UV lamp 340 emits UV radiation at 185 nm. The UV lamp may have a lamp power. The wavelength of the UV radiation and the lamp power are the factors that control the amount of ozone that is produced. The lamp power may range from 5 W to 30 W. An example UV lamp may include an Aquafine UV Lamp by Trojan Technologies. Irradiation of oxygen molecules 350 (O₂) may produce oxygen atoms (O). The oxygen atoms may combine with subsequent oxygen molecules 350 to form ozone 360 (O₃). A gas exiting the ozone generator 130 includes the formed ozone 360 and air.

A system 100 for purifying water includes a mixing injector 140. The mixing injector 140 is fluidly connected to and downstream of the atmospheric water harvester 110. The mixing injector 140 is also fluidly connected to and downstream of the ozone generator 130. The mixing injector 140 is configured to mix water generated from the atmospheric water harvester 110 with ozone generated by the ozone generator 130. The mixing injector 140 may include a water inlet configured to accept the water, an ozone inlet configured to accept the ozone, a mixing chamber configured to mix and water and ozone to produce ozonated water, and an outlet configured to direct the ozonated water downstream of the mixing injector 140. The mixing injector 140 may be a Venturi injector. Other mixing injectors may include ozone diffusers (Ozone Solutions), ozone spargers (Ozone Solutions), or an ozone contact tank with agitation (Trojan Technologies).

The mixing injector 140 is depicted in further detail in FIG. 4. The mixing injector 140 may have an overall length ranging from 50 to 80 millimeters. The mixing injector 140 may be made of an ozone resistant material. Ozone resistant materials may include, but are not limited to, polyvinyl chloride (PVC), polyvinylidene fluoride (PVDF), anodized aluminum, borosilicate glass, titanium, propylene, carbon steel, and stainless steel.

The mixing injector 140 includes a water inlet 410. The water inlet 410 includes tubing to accept water from the atmospheric water harvester 110. The tubing may be, but is not limited to, Teflon, silicon, stainless steel (304 or 316), polyvinylidene fluoride (PVDF), high density polyethylene (HDPE), or polyvinyl chloride (PVC). The tubing may have an inner diameter (ID) ranging from 4 to 6 millimeters (mm). A pump is used to move the water through the tubing in the mixing injector 140. The pump may be an electrical diaphragm pump. An example electrical diaphragm pump is a Flojet by Raptor Supplies. The pressure produced by the electrical diaphragm pump may range from 1.5 to 3 bar. The water from the atmospheric water harvester 110 may have an initial flow rate of 4 to 7 milliliters per minute (mL/min).

The mixing injector 140 includes an ozone inlet 420. The ozone inlet 420 includes tubing to accept ozone from the ozone generator 130. The ozone may be a gas that includes air. The tubing may be Teflon, silicon, stainless steel (304 or 316), polyvinylidene fluoride (PVDF), high density polyethylene (HDPE), or polyvinyl chloride (PVC). The tubing may have an inner diameter (ID) ranging from 4 to 6 mm.

The mixing injector 140 includes a mixing chamber 430. The mixing chamber 430 is configured to mix water from the atmospheric water harvester 110 with ozone from the ozone generator 130. The mixing chamber 430 may produce ozonated water. The mixing chamber 430 may include a throat diameter. The throat diameter is a reduced diameter inside the mixing injector 140 that allows for controlling the pressure of the flow and thus controlling the flow rate. The throat diameter may have a diameter ranging from 0.5 to 1 mm. The throat diameter may be adjusted with a flow rate adjuster. A reduced diameter from the water inlet 410 to the throat diameter may produce a high pressure flow, thereby producing a higher flow rate. A higher flow rate through the mixing injector 140 creates suction at the ozone inlet 420. The higher flow rate may range from 4 to 7 mL/min.

The mixing injector 140 includes an outlet 440. The outlet 440 is configured to direct the ozonated water downstream of the mixing injector 140. The outlet 440 includes tubing to direct the ozonated water out of the mixing injector 140. The tubing may be Teflon, silicon, stainless steel (304 or 316), polyvinylidene fluoride (PVDF), high density polyethylene (HDPE), or polyvinyl chloride (PVC). The tubing may have an inner diameter (ID) ranging from 4 to 6 mm. The inner diameter of the tubing of the outlet 440 may increase the diameter inside the mixing injector 140. The increase may reduce the pressure of the ozonated water, thereby reducing the flow rate. The flow rate leaving the mixing injector may be 4 to 7 mL/min.

A system 100 for purifying water includes a contact chamber 150. The contact chamber 150 is in fluid communication with the mixing injector 140. The contact chamber 150 is configured to hold the ozonated water for a period of time required in order to disinfect the water. The period of time required for disinfection may range from 5 to 30 minutes. The period of time required for disinfection is dependent on the volume of the contact chamber. A larger contact chamber requires a longer period of time for disinfection. The contact chamber may be made of stainless steel (304 or 316). Example dimensions of the contact chamber may include a radius of 2 cm and a height of 8.4 cm. The contact chamber may have a volume ranging from 105 to 150 mL.

After the contact chamber, the purified water may be stored. The storage tank may be made from a corrosion-resistant stainless steel. An example of corrosion-resistant stainless steel may include Food Grade stainless steel 304 or 316. The storage tank may have a volume capacity of at least 24 liters. Dimensions for the storage tank may include, but are not limited to, a length of 40 cm, a width of 20 cm, and a height of 30 cm.

### Method for Purifying Water

A method for purifying water is depicted in the flowchart of FIG. 5. The method 500 includes, at block 510, condensing water from an atmosphere with an atmospheric water harvester. The atmospheric water harvester is as previously described. To condense water from the atmosphere, the atmospheric humidity may be at least 50% at 25 °C. In one or more embodiments, the atmospheric humidity is at least 70% at 25 °C. Condensing water from the atmosphere may include pulling air from the atmosphere into the atmospheric water harvester. A fan system may pull the air in at a speed ranging from 3,500 to 6,500 rpm with an air flow ranging from 4.85 to 5.5 m³/h. After pulling in air from the atmosphere, filtering the air with an air filter may remove particulates and pollutants from the air.

Condensing water from the atmosphere may include transferring heat from the air in an evaporator to cool the air down to its dew point. The dew point is dependent on temperature, pressure, and humidity of the air. The temperature may range from 20 to 35 °C. The pressure may range from 900 to 1,020 hectopascals (hPa). The humidity may be at least 50%. Transferring heat may occur by a refrigerant absorbing the heat from the air. Upon absorbing the heat, the refrigerant may become a low pressure refrigerant vapor. Compressing the low pressure refrigerant vapor in a compressor may convert it into a high pressure, high temperature vapor. The high pressure, high temperature refrigerant may release the heat in a condenser and become a high pressure refrigerant liquid. An expansion valve may further reduce the pressure and temperature of the liquid refrigerant. The refrigerant liquid may be transferred back to the evaporator to again absorb heat, creating a cycle of heating and cooling. The water in the air may condense once at the dew point and collect in the water collection tank. The atmospheric water harvester may condense 0.05 to 0.25 liters of water per hour.

The method 500 includes, at block 520, generating ozone with a UV lamp in an ozone generator. Generating ozone may include drawing air including oxygen molecules inside the ozone generator. The ozone generator is as previously described. A fan may draw air including oxygen molecules inside the ozone generator at an air flow rate ranging from 1 to 3 liters of air per minute. An air velocity in the ozone generator based on 10 cm² cross sectional area may range from 0.0167 to 0.05 meters per second (m/s).

Generating ozone may include producing radiation from a UV lamp. The radiation may have a wavelength of 185 nm. A power source of 5 to 30 watts may be required to heat the UV lamp in order to generate the radiation.

Irradiating oxygen molecules (O₂) with the UV lamp may produce oxygen atoms. Irradiation may occur over a period of time ranging from 10 to 15 seconds. Irradiating the oxygen molecules may split the oxygen molecules to produce oxygen atoms (O). Combing the oxygen atoms with oxygen molecules may form ozone (O₃). Generating ozone with the UV lamp may include generating ozone in an amount ranging from 1000 to 2000 milligrams (mg) of ozone per hour.

The method 500 includes, at block 530, mixing water with ozone in a mixing injector to yield ozonated water. The mixing injector is as previously described. In one or more embodiments, the mixing injector is a Venturi injector. Water generated from the atmospheric water harvester may be mixed into the mixing injector at a flow rate ranging from 4 to 7 milliliters per minute. Ozone may be mixed into the water based on suction created from a change in pressure. The change in pressure may be provided by the pump used to move the water through the tubing in the mixing injector 140. Ozone generated from the ozone generator may be mixed into the mixing injector at a rate ranging from 1 to 1.5 L/min. An amount of ozone ranging from 0.4 to 0.6 mg/L water generated may be required for disinfection. In one or more embodiments, the amount of ozone required for disinfection if 0.5 mg/L water generated.

Ozone may be mixed with water for a period of time ranging from 0.5 to 3 seconds. The flow rate of the ozonated water from the mixing injector may range from 4 to 7 mL/min.

The method 500 includes, at block 540, holding the ozonated water in a contact chamber for a period of time required for disinfection. After the period of time required, the method 500 produces purified water. The period of time required for disinfection may range from 5 to 30 minutes. Ozone has a high oxidation potential. Oxidation damages vital cell components such as cell walls, membranes, lipids, proteins, and nucleic acids. The damage may kill the cells, thus purifying the water. Upon oxidation, ozone is converted back to oxygen molecules.

Disinfection of the water may be confirmed by testing. Tests such as ozone residual tests or microbial tests may be used. Ozone residual tests may use a test kit or an ozone meter. An ozone residual level in the range of 0.1 to 0.3 mg/L may indicate effective disinfection. Microbial tests may also be bacterial culture tests. The bacterial culture test may detect if harmful bacteria and pathogens are present in the water. The test is done through sampling the ozonated water and conducting a colony-forming unit (CFU) test or most probable number (MPN) test.

The purified water may be stored in a storage tank. The storage tank may be made from a corrosion-resistant stainless steel. An example of corrosion-resistant stainless steel may include Food Grade stainless steel 304 or 316, The storage tank may have a volume capacity of at least 24 liters. Dimensions for the storage tank may include, but are not limited to, a length of 40 cm, a width of 20 cm, and a height of 30 cm.

Embodiments of the present disclosure may provide at least one of the following advantages. The systems and methods described herein produce safe drinking water from air in the atmosphere. Air from the atmosphere is readily available. Using air to generate water is also more economical than water from other sources. Further, the systems and methods described herein integrate water harvesting with disinfection, thereby providing disinfected drinking water from air in the atmosphere.

Another advantage of embodiments of the present disclosure includes that purifying water with ozone does not leave harmful byproducts. Known methods of purification include the use of chlorine, which leaves byproducts after purification. Further, systems and methods described herein use UV radiation to generate ozone which is safer than other known methods. Other known methods include corona discharge, which may require electricity with a high voltage. Corona discharge may require a voltage ranging from 5 to 15 kilovolts (kV). Ozone generated by UV lamp may require a voltage ranging from 30 to 100 V.

### EXAMPLES

### Example 1: Calculations of Cross-Sectional Area and Air Velocity of the Ozone Generator

A volumetric flow rate of 1 liter/min (0.001 m³/min) was assumed. The cross-sectional area and air velocity of the ozone generator was calculated to determine and optimize the corresponding chamber length and volume. A cross-sectional area of 10 cm² is selected (0.001 m²).

Calculation of required air velocity at the proposed cross-sectional area:

(Q=A×v)

Given:

(Q=0.001 m³/min=1.67×10⁻⁵ m³/s)

(A=0.001 m²)

[v=Q/A=1.67×10⁻⁵ m³/s/0.001 m²=0.0167 m/s]

### Example 2: Calculations of Volume of the Ozone Generator

The desired cross-sectional area (A) was 10 cm² (0.001 m²). The airflow rate was 1 liter per minute (0.001 m³/min).

### 1. Defining Cross-Sectional Area:

[A=10 cm²=0.001 m²]

### 2. Calculating Air Velocity

The air velocity is 0.0167 m/s as calculated in Example 1.

### 3. Computing Chamber Length—Effective Exposure:

It was assumed an effective air exposure needing fewer seconds. 10 seconds of exposure was selected.

$$[ Length = \frac{v}{Residence Time} = 0.0167 m / s \times 10 seconds = 0.167 m ]$$

### 4. Volume:

[V=A×L=0.001 m²×0.167 m=1.67×10⁻⁴ m³=167 cm³

### Example 3: Contact Chamber Design Calculations

Key parameters for the contact chamber include a flow rate of 0.25 liters per hour (approximately 0.00417 liters per minute or 4.17 mL per minute). A contact volume of 105 mL was used.

The contact time (t) is given by the volume of the chamber divided by the flow rate of water:

t=chamber volume/flow rate

t=105 mL/4.17 mL/min

t=25.18 min

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for purifying water comprising:
an atmospheric water harvester;
a mixing injector fluidly connected to and downstream of the atmospheric water harvester;
an ozone generator fluidly connected to and upstream of the mixing injector; and
a contact chamber in fluid communication with the mixing injector.

2. The system of claim 1, wherein the atmospheric water harvester comprises:
a fan system comprising an air filter;
an evaporator fluidly connected to the fan system and configured to produce water and a refrigerant vapor;
a condenser fluidly connected to the evaporator and configured to produce a refrigerant liquid;
a compressor fluidly connected to the evaporator and condenser; and
a water collection tank fluidly connected to the evaporator.

3. The system of claim 1, wherein the ozone generator comprises:
a fan;
an ozone generator chamber fluidly connected to the fan;
a UV lamp contained inside the ozone generator chamber; and
a power source connected to the UV lamp.

4. The system of claim 3, wherein the UV lamp emits UV radiation at 185 nm.

5. The system of claim 1, wherein the mixing injector comprises:
a water inlet configured to accept water;
an ozone inlet configured to accept ozone;
a mixing chamber configured to mix the water and ozone to produce ozonated water; and
an outlet configured to direct the ozonated water downstream of the mixing injector.

6. The system of claim 1, wherein the mixing injector is a Venturi injector.

7. The system of claim 1, wherein the contact chamber has a volume ranging from 105 to 150 mL.

8. A method for purifying water comprising:
condensing water from an atmosphere with an atmospheric water harvester;
generating ozone with a UV lamp in an ozone generator;
mixing the water with the ozone in a mixing injector to yield ozonated water; and
holding the ozonated water in a contact chamber for a period of time required for disinfection, thereby producing purified water.

9. The method of claim 8, wherein condensing water from an atmosphere with an atmospheric water harvester comprises an atmospheric humidity of at least 50% at 25 °C.

10. The method of claim 8, wherein condensing water from the atmosphere with an atmospheric water harvester comprises condensing 0.05 to 0.25 liters of water per hour.

11. The method of claim 8, wherein generating ozone with a UV lamp comprises:
drawing air comprising oxygen molecules into the ozone generator;
irradiating oxygen molecules with the UV lamp thereby producing oxygen atoms; and
combining the oxygen molecules and the oxygen atoms to form ozone.

12. The method of claim 8, wherein generating ozone with a UV lamp comprises generating ozone in an amount ranging from 1000 to 2000 mg ozone per hour.

13. The method of claim 8, wherein the mixing injector is a Venturi injector.

14. The method of claim 8, wherein mixing the water with the ozone comprises mixing the water at a flow rate ranging from 4 to 7 milliliters per minute.

15. The method of claim 8, wherein mixing the water with the ozone comprises mixing the ozone at a rate ranging from 1 to 1.5 liters per minute.

16. The method of claim 8, wherein the period of time required for disinfection ranges from 5 to 30 minutes.

17. The method of claim 8, wherein disinfection includes mixing an amount of ozone ranging from 0.4 to 0.6 mg per liter of water condensed.
